(19) United States
(12) Patent Application Publication
(10) Pub. No.: US 2008/0037096 A1
(43) Pub. Date: Feb. 14, 2008

(54) Method for Generating Broadband Light Sideband and Apparatus for Generating Broadband Light Sideband

(75) Inventors: Shintaro Hisatake, Osaka (JP); Tetsuro Kobayashi, Hyogo (JP)

Correspondence Address: CHAPMAN AND CUTLER, 111 WEST MONROE STREET, CHICAGO, IL, 60603, US

(73) Assignee: Osaka University, Suita-shi (JP)

(21) Appl. No.: 10/580,292

(22) PCT Filed: Nov. 25, 2004
(86) PCT No.: PCT/JP04/17468

§ 371 Date: Feb. 27, 2007

(30) Foreign Application Priority Data
Nov. 25, 2003 (JP) 2003-394218

(51) Int. Cl. G02F 1/03

(52) U.S. Cl. 359/245

(57) ABSTRACT

A light sideband sequence having a uniform intensity distribution is generated by inputting a light beam to an electro-optic phase modulator from a laser source, subjecting a phase modulation to the light beam and setting a predetermined spatial distribution of the phase modulation index to cancel out the spatial distribution of the light beam.

### FIELD OF THE INVENTION

The present invention relates to a method for generating a broadband light sideband and an apparatus for generating a broadband light sideband.

### BACKGROUND OF THE INVENTION

As a method for generating a light sideband, a method using a mode-locked laser (MLL) and a method using an external phase modulator have been used so far. As a method using MLL, a method for generating a light sideband of a spectrum over two octaves using a nonlinear optical fiber is established. However, the light sideband sequence generated in this method has a small frequency interval of several hundred MHz, which is not sufficient in application for an optical communication system etc. Further, it is not easy to control the frequency interval of the light sideband sequence electrically. In addition, MLL being generally large and expensive, it is extremely hard to utilize it as a basic instrument applicable for the industrial base.

With a method using an external phase modulator, on the other hand, the frequency interval of the light sideband sequence can be made sufficiently large, for instance 10 GHz or more, and compact light sources of various kinds can advantageously be used. Further, the interval of the light sideband sequence can easily be controlled electrically. However, the amplitude of each sideband following the Bessel function, it is lacking in uniformity and there can happen that the sideband amplitude of a certain order is 0.

### DESCRIPTION OF THE PRESENT INVENTION PROBLEMS TO BE SOLVED

The present invention is intended for generating a light sideband sequence having a sufficiently large frequency interval, and each having a uniform intensity.

### MEANS FOR SOLVING THE PROBLEMS

The present invention relates to a method for generating a broadband light sideband, comprises the steps of: inputting a light beam from a predetermined light source to an electro-optic phase modulator; generating a light sideband sequence by phase modulating the light beam in the electro-optic phase modulator; and making an intensity distribution of said light sideband sequence uniform by setting a predetermined spatial distribution of the phase modulation index within the beam cross-section in consideration with the spatial intensity distribution of said light beam.

Also, the present invention relates to an apparatus for generating a broadband light sideband, comprises: a predetermined light source; and an electro-optic phase modulator for generating a light sideband sequence by subjecting a phase modulation to a light beam emitted from said light source, and making an intensity distribution of said light sideband uniform by setting a predetermined spatial distribution of the phase modulation index in consideration with the spatial intensity distribution of said light beam.

According to the present invention, the frequency interval of the light sideband sequence can arbitrarily controlled based on the phase modulation frequency in the phase modulator with the use of the electro-optic phase modulator as an external phase modulator in generating the light sideband sequence. Thus, it is possible to increase the frequency interval of the light sideband sequence sufficiently by increasing the phase modulation frequency for instance to several GHz.

Moreover, in the electro-optic phase modulator, by setting a predetermined spatial distribution of phase modulation index in consideration with the spatial intensity distribution of the light beam used for generating the light sideband sequence and equalizing the nonuniformity of the sideband generated in the phase modulation, it is possible to make the intensity distribution of the light sideband sequence uniform.

Therefore, according to the method of the present invention, a sufficient increase in the frequency interval in the intended light sideband sequence can be achieved, which is difficult with the conventional method using MLL and a nonlinear element, as well as the equalization of the intensity distribution of the light sideband sequence, which is impossible with the conventional method using the external phase modulator.

The spatial distribution of the phase modulation index is achieved by controlling the configuration of the electrode of the phase modulator in case, for example, the frequency of the modulation wave used for phase modulation is sufficiently low that a velocity mismatching between the light beam used for generating the light sideband sequence and the modulation wave is negligible in the electro-optic phase modulator. Specifically, the electrode is formed in such a way that the configuration thereof conforms with the configuration of the spatial distribution of the phase modulation index.

In addition, the electrode is installed on a pair of facing principal surfaces of the electro-optic crystal included in the electro-optic phase modulator, the surfaces extending generally parallel to the traveling direction of the light beam.

In case, on the other hand, the frequency used for phase modulation increases for example to several GHz and the velocity mismatching between the beam subjected to generation of the light sideband sequence and the modulation wave is not negligible in the electro-optic phase modulator, a quasi-velocity matching between the light beam and the modulation wave is obtained by applying a polarization reversal technique in the phase modulator.

In addition, the polarization reversal technique is applied to the electro-optic crystal included in the phase modulator. The electro-optic crystal is a main material comprising the majority of the phase modulator.

By providing a means for spatial Fourier transformation in the backward of the electro-optic phase modulator, the light beam having been modulated in the light beam cross-section thereof by the electro-optic phase modulator with various modulation indices and comprising a sequence of light sidebands corresponding to each modulation index is added up using the spatial Fourier transformation. Thus, the intensity of the light beam comprising the light sideband sequence can always be kept constant.

An output means is appropriately provided to extract the output of the light beam in the backward of the electro-optic phase modulator, or of the spatial Fourier transformation means in case it is provided.

### EFFECTS OF THE INVENTION

As described above, according to the present invention, the light sideband sequence can be generated with a sufficiently large frequency interval and a uniform intensity of each sideband.

### BRIEF DESCRIPTION OF THE DRAWINGS

FIG. 1 is a configuration diagram illustrating schematically an example of an apparatus for generating a broadband light sideband according to the present invention.

FIG. 2 is a configuration diagram illustrating schematically another example of an apparatus for generating a broadband light sideband according to the present invention.

FIG. 3 is a configuration diagram illustrating schematically a modification example of an apparatus for generating a broadband light sideband as shown in FIG. 2.

FIG. 4 is a configuration diagram illustrating schematically another modification example of apparatus for generating a broadband light sideband as shown in FIG. 2.

### BEST MODE FOR CARRYING OUT THE INVENTION

A detailed description as well as other characteristics and advantages of the present invention is described below based on the best mode for carrying out the invention.

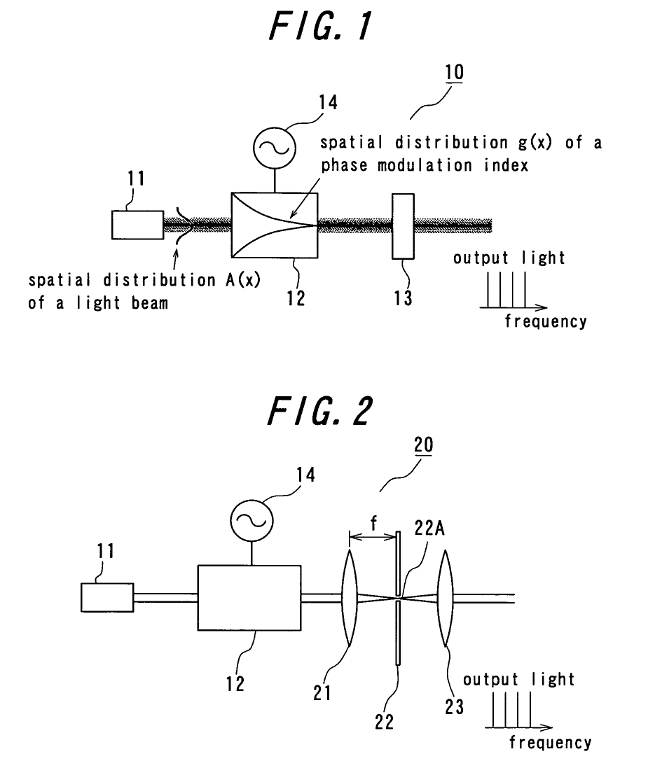

FIG. 1 is a configuration diagram illustrating schematically an example of an apparatus for generating a broadband light sideband according to the present invention. In an apparatus 10 shown in FIG. 1 for generating a sideband, a laser source 11, an electro-optic phase modulator 12 in the backward thereof and a light beam output means 13 are each provided in order of precedence. A high frequency power source 14 is further connected to an electro-optic phase modulator 12.

A light beam having a predetermined spatial distribution A(x) is emitted from the laser source 11 and introduced into the electro-optic phase modulator 12 to be modulated by a modulation wave generated in the high frequency power source 14 (a modulation wave is superimposed). In this process, a plurality of sidebands from a low order to a high order (a sideband sequence) are formed in the light beam.

In the conventional method, since the phase modulation index is constant over the whole beam, an uneven modulation sideband corresponding to the modulation index and similar to Bessel function is generated, so that there can happen that the sideband intensity of a specific index is almost zero. In the present invention, on the other hand, a spatial distribution g(x) of the phase modulation index is provided in the electro-optic phase modulator 12, sidebands of different modulation index are added up weightedly on account of spatial distribution A(x), so that the intensity of a sideband sequence become uniform. As a result, a light sideband sequence of uniform intensity can be obtained.

When considering the spatial distribution g(x) of the phase modulation index, the phase of the light beam is modulated with the formula ψ (t,x)=g(x) sin (2 π fmt), wherein fm represents the frequency of the modulation wave and t represents the time. Thus, the frequency of the light beam being f₀, the light beam is represented by formula 1, so that a sequence of sidebands lined up based on each modulation frequency is generated at position x at the output end of the crystal.

$$A ( x ) exp [ j ( 2 π {f}_{0} t - g ( x ) sin ( 2 π {f}_{m} t ) ) ] = {\sum }_{n = - ∞}^{n = ∞} A ( x ) {J}_{n} ( g ( x ) ) exp [ j ( 2 π ( {f}_{0} - {nf}_{m} ) t ) ] \qquad ( Formula 1 )$$

The amplitude (intensity) of each sideband is represented by the formula A(x)Jn(g(x)), the spatial distribution of the phase modulation index g(x) is determined based on the above formula in such a way that the amplitude (intensity) of each sideband corresponding to each value n become constant.

In case the frequency of the modulation wave applied from the high frequency power source 14 is relatively small and a velocity mismatching with the light beam is negligible, desired spatial distribution g(x) of the phase modulation index is obtained by controlling the configuration of the electrode in the electro-optic phase modulator 12. More specifically, the configuration of the electrode is formed to be conformed with the configuration of spatial distribution g(x) of the phase modulation index. The electrode is installed on a pair of facing principal surfaces of the electro-optic crystal included in the electro-optic phase modulator, the surfaces extending generally parallel to the traveling direction of the light beam.

If the frequency of the modulation wave applied from the high frequency power source 14 is relatively large, in an order of several GHz for example, a polarization reversal technique is applied to the electro-optic crystal included in the electro-optic phase modulator 12, so that a crystal axis of the electro-optic crystal is reversed with certain width W under the condition of a constant period.

Specifically, it is preferable to operate the polarization reversal in the half-period of L=[2 fm(1/Vgopt−1/Vpmod)]⁻¹, wherein fm represents the frequency of the modulation wave, Vgopt represents the group velocity of the light beam and Vpmod represents the phase velocity of the modulation wave. If the light beam has Gaussian distribution for example, the spatial distribution of the modulated index is represented by g(x)=8 nmL/λ sin (π W (x)/(2 L)) having the period of 2 L, wherein nm represents the change of the refraction index caused by the impression of electric field on the electro-optic crystal, λ represents the wavelength of the light beam, L represents the period of the polarization reversal, and W(x) represents the polarization reversal width depending on the position x.

The electro-optic crystal is a main material comprising the majority of the electro-optic phase modulator 12.

FIG. 2 is a configuration diagram illustrating schematically another example of an apparatus for generating a broadband light sideband according to the present invention. An apparatus 20 for generating a broadband light sideband shown in FIG. 2 is different from the apparatus 10 for generating a broadband light sideband shown in FIG. 1 in that it comprises a convex lens 21 as a means to operate a spatial Fourier transformation behind the electro-optic phase modulator 12, a diffraction plate 22 provided with a slit 22A and an additional convex lens 23 behind the lens 21, while other elements are the same as in the apparatus 10 in FIG. 1. Thus, the phase modulation of the light beam emitted from laser source 11 can be operated in the same way to obtain the desired light sideband sequence. The diffraction plate 22 and the additional convex lens 23 are constituent of the output means for outputting the light beam.

The convex lens 21 is provided as a means for operating a spatial Fourier transformation in the backward of the electro-optic phase modulator 12. The light beam having been modulated in the cross-section thereof by the electro-optic phase modulator 12 with various modulation indices and comprising a sequence of light sidebands corresponding to each modulation index is added up by the convex lens 21 as a means for operating spatial Fourier transformation. The intensity of the light beam including the light sideband sequence can always be kept constant in this way.

The diffraction plate 22 is placed so that the slit 22A conforms with the focal point f of the convex lens 21. The light beam having passed through the convex lens 21 is narrowed by the slit 22A to be output via the additional convex lens 23.

A concave mirror can be substituted for the convex lens 23 as a means for operating a spatial Fourier transformation.

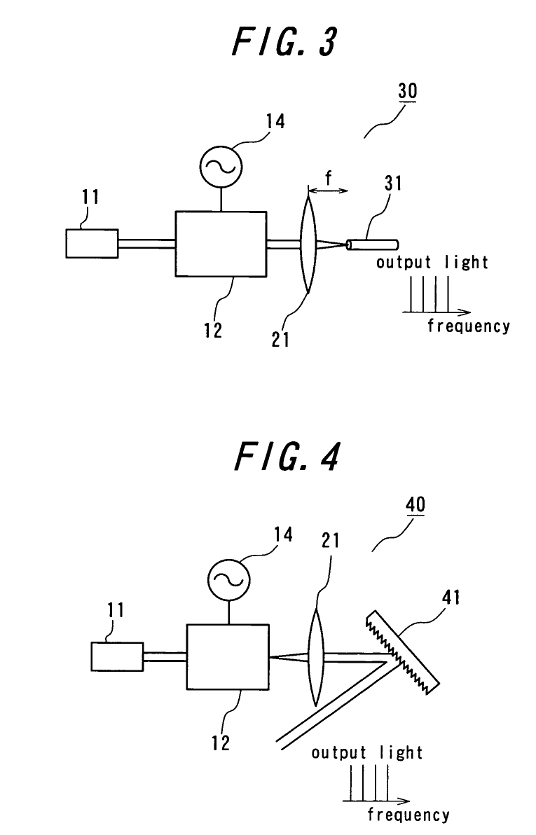

FIG. 3 is a configuration diagram illustrating schematically a modification example of an apparatus as shown in FIG. 2 for generating a broadband light sideband. In an apparatus 30 for generating a broadband light sideband as shown in FIG. 3, an optical fiber 31 is provided instead of the diffraction plate 22 and the additional convex lens 23 shown in FIG. 2 as an outputting means. The optical fiber 31 is provided in such a way that the input end thereof conforms with the focal point f of the convex lens 21 as a means for operating spatial Fourier transformation. In this case, a spatial Fourier transformation is operated with the convex lens 21 on the output light beam comprising the generated light sideband sequence, which is then introduced into the optical fiber 31 to be output.

FIG. 4 is a configuration diagram illustrating schematically another modification example of an apparatus as shown in FIG. 2 for generating a broadband light sideband. In an apparatus 40 as shown in FIG. 4 for generating a broadband light sideband, a diffraction grating 41 is provided instead of the diffraction plate 22 and the additional convex lens 23 in FIG. 2 as an outputting means. In this case, a spatial Fourier transformation is operated in convex lens 21 on the output light beam comprising the generated light sideband sequence, which is then diffracted with a diffraction grating 41 to be output.

While the present invention has been explained above in detail with some specific examples based on the mode for carrying out the invention, the invention is not to be considered as limited thereto, and various changes and modifications may be made without departing from the scope of the invention. For example, while the laser source is used in the above example, any light source can also be used instead. A light beam of any distribution configuration can be used by appropriately choosing a spatial distribution g(x) of the phase modulation index.

In the same manner, while the intensity distribution of the light sideband sequence, for instance, is made uniform in the present invention, it is possible to generate a light sideband sequence of any intensity envelope besides the flat sideband distribution.

### INDUSTRIAL APPLICABILITY

The present invention can be used in various fields such as optical electronics, optical information processing, optical communication, optical measurement and optical recording. More specifically, it can be applied to an optical frequency synthesizer, an optical pulse synthesizer, an optical frequency comb generator, an ultra short pulse generator and a light source for wavelength division multiplexing.

1. A method for generating a broadband light sideband, comprising the steps of:
inputting a light beam from a predetermined light source to an electro-optic phase modulator;
generating a light sideband sequence by subjecting a phase modulation to said light beam in said electro-optic phase modulator; and
making an intensity distribution of said light sideband sequence uniform by setting a predetermined spatial distribution of a phase modulation index in consideration with the spatial distribution of said light beam in said electro-optic phase modulator.

2. The method for generating a broadband light sideband according to claim 1, wherein the spatial distribution of said phase modulation index is formed by controlling a configuration of an electrode in said electro-optic phase modulator.

3. The method for generating a broadband light sideband according to claim 1, wherein the spatial distribution of said phase modulation index is formed by operating a polarization reversal technique in said electro-optic phase modulator.

4. The method for generating a broadband light sideband according to claim 3, wherein said polarization reversal technique is performed by reversing a crystal axis of an electro-optic crystal in said electro-optic phase modulator with a period L defined in the formula L=[2 fm(1/Vgopt-1/Vpmod)]⁻¹ (fm: a frequency of the modulation wave, Vgopt: a group velocity of said light beam, Vpmod: a phase velocity of the modulation wave).

5. The method for generating a broadband light sideband according to claim 4, wherein the spatial distribution g(x) of said phase modulation index is represented by the formula g(x)=8 nmL/λ sin (π W (x)/(2 L)), (nm: a change in the refraction index of the electro-optic crystal caused by the phase modulation, λ: a wavelength of the light beam, L: a period of the polarization reversal, W(x): a polarization reversal width).

6. The method for generating a broadband light sideband according to claim 1, further comprising a step of performing a spatial Fourier transformation on an output light beam including said light sideband sequence after emitted from said electro-optic phase modulator.

7. The method for generating a broadband light sideband according to claim 6, wherein said spatial Fourier transformation is performed by using a convex lens.

8. The method for generating a broadband light sideband according to claim 6, wherein said spatial Fourier transformation is performed by using a concave mirror.

9. An apparatus for generating a broadband light sideband comprising:
a predetermined light source; and
an electro-optic phase modulator for generating a light sideband sequence by subjecting a phase modulation to a light beam emitted from said light source and making an intensity distribution of said light sideband uniform by setting a predetermined spatial distribution of the phase modulation index in consideration with the spatial distribution of said light beam.

10. The apparatus for generating a broadband light sideband according to claim 9, wherein said electro-optic phase modulator comprises an electrode controlled into a predetermined configuration for generating said spatial distribution of the phase modulation index.

11. The apparatus for generating a broadband light sideband according to claim 10, wherein a polarization reversal technique is applied to said electro-optic phase modulator for generating said spatial distribution of the phase modulation index,

12. The apparatus for generating a broadband light sideband according to claim 11, wherein said polarization reversal technique is performed by reversing a crystal axis of an electro-optic crystal in said electro-optic phase modulator with a period L defined in the formula L=[2 fm(1/Vgopt-1/Vpmod)]⁻¹ (fm: a frequency of the modulation wave, Vgopt: a group velocity of said light beam, Vpmod: a phase velocity of the modulation wave).

13. The apparatus for generating a broadband light sideband according to claim 12, wherein the spatial distribution g(x) of said phase modulation index is represented by the formula g(x)=8 nmL/λ sin (π W (x)/(2 L)), (nm: a change in the refraction index of the electro-optic crystal caused by the phase modulation, λ: a wavelength of the light beam, L: a period of the polarization reversal, W(x): a polarization reversal width).

14. The apparatus for generating a broadband light sideband according to claim 9, further comprising a means for performing a spatial Fourier transformation on the output light beam including said light sideband after emitted from said electro-optic phase modulator.

15. The apparatus for generating a broadband light sideband according to claim 14, wherein said means for operating a spatial Fourier transformation comprises a convex lens.

16. The apparatus for generating a broadband light sideband according to claim 14, wherein said means for operating a spatial Fourier transformation comprises a concave mirror.

17. The apparatus for generating a broadband light sideband according to claim 9, further comprising a light beam output means for outputting an output light beam including said light sideband sequence.

18. The apparatus for generating a broadband light sideband according to claim 17, wherein said light beam output means comprises a diffraction grating.

19. The apparatus for generating a broadband light sideband according to claim 15, further comprising a light beam output means for outputting an output light beam including said light sideband sequence, wherein said light beam output means comprises a diffraction plate provided with a slit placed at a focal point of said convex lens and an additional convex lens.

20. The apparatus for generating a broadband light sideband according to claim 15, further comprising a light beam output means for outputting an output light beam including said light sideband sequence, wherein said light beam output means comprises an optical fiber.
